(19) United States
(12) Patent Application Publication
(10) Pub. No.: US 2011/0218320 A1
(43) Pub. Date: Sep. 8, 2011

(54) MODIFIED ZINC SALTS OF C4-8-ALKANEDICARBOXYLIC ACIDS AND USE THEREOF AS A POLYMERIZATION CATALYST

(75) Inventors: Tobias Heinz Steinke, Speyer (DE); Anna Katharina Ott, Mannheim (DE); Hans-Helmut Görtz, Freinsheim (DE)

(73) Assignee: BASF SE, Ludwigshafen (DE)

(21) Appl. No.: 13/041,888

(22) Filed: Mar. 7, 2011

Related U.S. Application Data
(60) Provisional application No. 61/310,725, filed on Mar. 5, 2010.

(51) Int. Cl. C08G 65/26; C07F 3/06

(52) U.S. Cl. 528/405; 556/118

(57) ABSTRACT

Zinc salts of C₄₋₈-alkanedicarboxylic acids, obtainable by reacting C₄₋₈-alkanedicarboxylic acids with surface-modified zinc oxide particles, said surface-modified zinc oxide particles being obtainable by treatment of zinc oxide particles with organosilanes, silazanes and/or polysiloxanes and subsequent heat treatment and/or UV irradiation of treated zinc oxide particles, and the use thereof as polymerization catalysts for the preparation of polyalkylene carbonates.

### CROSS-REFERENCE TO RELATED APPLICATIONS

This application claims benefit under 35 U.S.C. §119(e) of U.S. Provisional Application 61/310,725, filed Mar. 5, 2010.

### BACKGROUND OF THE INVENTION

Polyalkylene carbonates such as polypropylene carbonate are obtained by alternating copolymerization of carbon dioxide and alkylene oxide such as propylene oxide. For this purpose, a wide variety of different homogeneous and heterogeneous catalysts are used. The heterogeneous catalysts used are in particular zinc glutarates.

WO 03/029325 describes processes for preparing aliphatic polycarbonates. In these processes, it is possible to use not only multimetal cyanide compounds but also zinc carboxylates, especially zinc glutarate or zinc adipate. The zinc glutarate catalyst is prepared by reacting triturated zinc oxide with glutaric acid in toluene. After the reaction, the water of reaction is distilled off by azeotropic means. Then the toluene solvent is distilled off, and the residue is dried under high vacuum.

For the zinc glutarate catalyst, the catalyst activity depends on the moisture content of the catalyst. In the fully dried state, zinc glutarate exhibits only a very low polymerization activity, if any. Only by virtue of addition of water or absorption of atmospheric moisture is the activity maximum attained. In addition, zinc glutarate catalyst powder tends to form lumps and can thus be metered only with difficulty, especially after prolonged storage time.

### BRIEF SUMMARY OF THE INVENTION

The invention relates to modified zinc salts of C₄₋₈-alkanedicarboxylic acids, to processes for the preparation thereof, to use thereof as catalysts, especially as polymerization catalysts for preparation of polyalkylene carbonates, to processes for preparation of polyalkylene carbonates and to polyalkylene carbonates obtainable by the process.

It is an object of the present invention to provide improved polymerization catalysts for preparation of polyalkylene carbonates, which avoid the aforementioned disadvantages of the normal zinc glutarate catalysts and preferably additionally exhibit improved activity. In addition, the catalyst should preferably lead to an increase in the glass transition temperature in the polyalkylene carbonate obtained.

The objects are achieved in accordance with the invention by zinc salts of C₄₋₈-alkanedicarboxylic acids, obtainable by reacting C₄₋₈-alkanedicarboxylic acids with surface-modified zinc oxide particles, said surface-modified zinc oxide particles being obtainable by treatment of zinc oxide particles with organosilanes, silazanes and/or polysiloxanes and subsequent heat treatment and/or UV irradiation of treated zinc oxide particles.

It has been found in accordance with the invention that the surface modification of the zinc oxide particles which are used for preparation of the zinc salts of the C₄₋₈-alkanedicarboxylic acids lead to more active catalysts which have improved storage stability and meterability, give more stable polymerization results irrespective of the moisture range, and do not need any additional activation after drying. In addition, as a result of use of the inventive catalyst, the glass transition temperature rises for the polyalkylene carbonates obtained. The catalyst is essentially more finely divided than the unmodified zinc glutarate catalyst and does not tend to cake or to form lumps. The bulk density of the inventive silane-modified catalyst is much lower than the bulk density of the unmodified catalyst.

### DETAILED DESCRIPTION OF THE INVENTION

The inventive catalysts are prepared analogously to processes known from the prior art. For example, reference may be made to the procedure according to WO 03/029325, especially example 1 on page 22 therein. This involves using, instead of unmodified zinc oxide, surface-modified zinc oxide in particulate form. The surface modification of the zinc oxide is effected by treatment or coating with organosilanes, silazanes and/or polysiloxanes, and subsequent heat treatment and/or UV irradiation of the treated or coated zinc oxide particles.

Such surface-modified zinc oxide particles are known from the prior art and are described, for example, in EP-A-1 508 599 and WO 2006/092442. According to the invention, it is possible with preference to use surface-modified zinc oxide particles which are obtained according to EP-A-1 508 599 or WO 2006/092442. For the preparation of the zinc oxide particles and the properties thereof, reference may be made to these two publications.

The modified zinc oxide described in WO 2006/092442 is used in heterogeneous catalysis, especially for decomposition of chlorohydrocarbons, and in photovoltaics and for coating of photoelectrodes. The modified ZnO prepared according to EP-A-1 508 599 is used in cosmetics.

EP-A-1 508 599 also describes, in paragraph [0061], surface modifiers suitable in accordance with the invention. These are organosilanes, haloorganosilanes, silazanes or polysiloxanes, and cyclic polysiloxanes are also useful.

Particular preference is given in accordance with the invention to the treatment or coating of the zinc oxide particles with organosilanes, specifically with alkoxyalkylsilanes.

Preferred organosilanes correspond to (RO)₃Si(CₙH₂ₙ₊₁) and (RO)₃Si(CₙH₂ₙ₋₁) types where
R is alkyl such as methyl, ethyl, n-propyl, i-propyl, butyl, and
n is from 1 to 20, preferably 1 to 10.

Further preferred organosilanes correspond to R′ₓ(RO)_{y}Si(CₙH₂ₙ₊₁) and R′ₓ(RO)_{y}Si(CₙH₂ₙ₋₁) types where R and R′ are each independently alkyl such as methyl, ethyl, n-propyl, i-propyl, butyl, where R′ may also be cycloalkyl, n is from 1 to 20, x+y=3, x is 1 or 2, and y is 1 or 2.

Such suitable organosilanes are described in EP-A-1 508 599 in paragraph in sections a) and b). The alkoxyalkylsilanes described in WO 2006/092442 can likewise be used with preference in accordance with the invention; see especially page 3, last paragraph, page 4, first paragraph therein. Preferred alkoxyalkylsilanes are trimethoxyalkylsilanes. Preference is given to methyltrimethoxysilane, isooctyltrimethoxysilane, trimethoxyvinylsilane, triethoxyoctylsilane, 3-methacryoylloxypropyltrimethoxysilane, isooctyltriethoxysilane, methyltriethoxysilane, vinyltriethoxysilane, isobutylisopropyldimethoxysilane, 3-methacryloyloxypropylmethyldimethoxysilane, [3-(2,3-epoxypropoxy)propyl]trimethoxysilane, N-(2-aminoethyl)-3-aminopropyltrimethoxysilane, (3-methacryloyloxypropyl)methyldimethoxysilane, dicyclopentyldimethoxysilane, dimethoxymethyloctadecylsilane.

The organosilanes, silazanes and/or polysiloxanes can be used in any suitable amounts for modification of a ZnO particle. They are preferably used in a concentration of 0.1 to 15 mol %, especially of 2 to 10 mol %.

The treatment or coating of the zinc oxide particles with the organosilanes, silazanes and/or polysiloxanes can be effected in any suitable manner. For example, the surface modifier can be sprayed onto the zinc oxide. Optionally, the zinc oxide may be sprayed beforehand with water. The spraying can be effected at any suitable temperature, for example room temperature (22° C.). It is also possible to suspend or disperse the ZnO particles in a polar protic solvent, and then to treat them with the surface modifiers, specifically with alkoxyalkylsilanes. The polar protic solvents are preferably selected from the group consisting of aliphatic, aromatic or cyclic, mono- or polyhydric alcohols or thioalcohols and aldehydes. The polar protic solvent is preferably methanol.

When working in solvents, the treatment of the suspended and/or dispersed ZnO particles with the surface modifiers, especially alkoxyalkylsilanes, is performed preferably at a temperature of 40 to 70° C., especially at about 60° C.

The treatment or coating of the zinc oxide particles with the surface modifiers is followed by a heat treatment and/or UV irradiation of the treated zinc oxide particles. The UV irradiation can be performed as described in WO 2006/092442. The treated zinc oxide particles are preferably exposed to UV radiation in an aqueous medium. The duration of the UV irradiation can be selected freely. The treated zinc oxide particles are preferably exposed to the UV radiation for 45 to 90 minutes, especially about 60 minutes.

When the treatment or coating of the zinc oxide particles with the surface modifiers is followed by a heat treatment, it is preferably performed at a temperature in the range from 50 to 400° C. for a period of 1 to 6 hours. For corresponding procedures, reference may be made to EP-A-1 508 599.

Alternatively, the surface modifiers can also be applied to the zinc oxide in vapor form, which is followed by a thermal treatment in the range from 50 to 800° C. for 0.5 to 6 hours.

Zinc oxides used for modification in accordance with the invention may originate from any suitable sources. For example, it is possible to use zinc oxide as described in WO 92/13517 or DE-A-102 12 680. Nanoscale ZnO with a particle diameter of less than 100 nm can be prepared via precipitation reactions in the sol-gel process; see the references cited in WO 2006/092442 on pages 1 and 2.

The silane molecules, especially alkoxyalkylsilane molecules, are preferably bonded covalently to the ZnO particles, as a result of which an inorganic network of —O—Si—O—Si—O— units is formed in the aqueous medium under UV irradiation, some of which combine to form polycyclic silsesquioxane units.

Without being bound to a theory, it is possible that the subsequent heat treatment or UV radiation oxidizes the organic radicals of the silanes. Between individual ZnO particles, it is thus possible to form an inorganic oxidic network of —O—Si—O—Si—O— units, which bridges the particles and keeps them at defined distances. A material thus obtained has a high surface area of up to 130 m²/g.

In the UV treatment, which can also be effected with addition of H₂O₂ and/or with supply of air during the UV irradiation, preference is given to using UV light with a wavelength of less than 390 nm.

The mean particle size is preferably in the range from 50 to 300 nm. In one embodiment of the invention, the ZnO particles are nanoscale. This means that they have a mean diameter of not more than 100 nm.

In general, the zinc oxide may have a BET surface area of 10 to 200 m²/g. The surface-modified ZnO particles preferably have a surface area of at least 100 m²/g, determined by the BET method, as described, for example, in WO 2006/092442 on page 5.

The ZnO particles surface-modified in accordance with the invention preferably have a zinc content of at least 60% by weight, especially of 65 to 75% by weight, determined to DIN 55908.

The zinc oxide particles thus surface-modified lead, by virtue of reaction with C₄₋₈-alkanedicarboxylic acids, to preferred polymerization catalysts for preparation of polyalkylene carbonates. The surface-modified zinc oxide particles are preferably reacted with terminal C₄₋₈-alkanedicarboxylic acids. Preference is given to reacting them with glutaric acid, adipic acid or mixtures thereof. The zinc salts are preferably zinc glutarates or zinc adipates.

The zinc salts are prepared by performing the process steps specified.

The zinc salts can generally be used as catalysts and are especially suitable as polymerization catalysts for preparation of polyalkylene carbonates, especially of polypropylene carbonate.

The inventive catalysts exhibit the following advantages:
increase in the surface area and hence of improvement in the catalytic activity hydrophobization of the catalyst surface and hence decrease in the water absorption
polymerization at lower CO₂ pressures is possible and gives more polymer with better properties
reduction in the formation of by-products such as cyclic polycarbonates (cPC)
better handling of the catalyst owing to improved free flow and the possibility of handling under atmospheric oxygen
   no lump formation as the result of improved free flow, and hence improved storage stability.

The inventive catalysts are preferably used in a process for preparing polyalkylene carbonates by polymerizing carbon dioxide with at least one epoxide of the general formula (I):

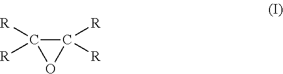

where R is independently H, halogen, NO₂, CN, COOR′ or C₁₋₂₀-hydrocarbyl radical which may be substituted, where one of the R radicals may be also OH, and where two R radicals together may form a C₃₋₅-alkylene radical, R′ is H or C₁₋₂₀-hydrocarbyl radical which may be substituted, wherein the polymerization is performed over an inventive catalyst.

One R in formula (I) may, for example, be a —CH₂—OH or —CH₂—O—C(═C)R′ radical. The C₃₋₅-alkylene radical is preferably a linear, terminal alkylene radical.

The catalyst is preferably used in anhydrous form. “Anhydrous” in the context of the invention means that the water content in the catalyst is preferably less than 1% by weight, more preferably not more than 10 ppm, based on the overall catalyst. “Anhydrous” means more preferably that the catalyst—apart from chemically bound water (for example water of crystallization)—comprises only insignificant traces of water, if any, more particularly does not comprise any water adhering to the surface or enclosed physically in cavities.

The epoxide used is preferably ethylene oxide, propylene oxide, butene oxide, cyclopentene oxide, cyclohexene oxide, i-butene oxide, acrylic oxides or mixtures thereof. Particularly preference is given to using propylene oxide, cyclohexene oxide, ethylene oxide or a mixture thereof. More particularly, propylene oxide is used.

For further possible epoxides, reference may be made to WO 03/029325, pages 6 and 7. In the case of use of CO₂ and two or more epoxides, the result is polycarbonate terpolymers. Useful mixtures of two epoxides include, for example, ethylene oxide and propylene oxide, ethylene oxide and cyclohexene oxide, propylene oxide and cyclohexene oxide, i-butene oxide and ethylene oxide or propylene oxide, butylene oxide and ethylene oxide or propylene oxide.

The ratio of carbon dioxide to epoxide can be varied within wide limits. Typically, carbon dioxide is used in excess, i.e. more than 1 mol of carbon dioxide per 1 mol of epoxide.

The process according to the invention preferably comprises essentially the following process steps:
1. drying or rendering anhydrous the catalyst,
2. initially charging the anhydrous catalyst in a polymerization reactor,
3. optionally adding an inert reaction medium,
4. adding carbon dioxide,
5. adding the epoxide,
6. heating the reactor to the reaction temperature,
7. optionally adding further carbon dioxide and
8. after the polymerization reaction has abated, working up the reactor contents to give the polycarbonate, where steps 5 and 6 may be exchanged.

The reaction can be performed in an inert reaction medium in which the catalyst can be dissolved or dispersed.

Suitable inert reaction media are all substances which do not adversely affect the catalyst activity, especially aromatic hydrocarbons such as toluene, xylene, benzene, and also aliphatic hydrocarbons such as hexane, cyclohexane, and also halogenated hydrocarbons such as dichloromethane, chloroform, isobutyl chloride. Equally suitable are ethers such as diethyl ether, and also tetrahydrofuran, diethylene glycol dimethyl ether (diglyme), dioxane and nitro compounds such as nitromethane. Preference is given to using toluene.

The inert medium can be injected into the polymerization reactor, for example, as such or preferably with a gas stream, in which case the gas used may be an inert gas such as nitrogen or else the CO₂ reactant.

The catalyst is preferably initially charged in the reactor, rendered anhydrous by heating in an inert gas stream and optionally cooled, and the inert reaction medium is injected into the reactor with gas while stirring.

Based on the catalyst solution or dispersion (sum of catalyst and reaction medium), the catalyst concentration is preferably 0.01 to 20% and especially 0.1 to 10% by weight.

Based on the sum of epoxide and inert reaction medium, the catalyst concentration is preferably 0.01 to 10% and more preferably 0.1 to 1% by weight.

In another, likewise preferred embodiment, no inert reaction medium is employed.

According to the invention, the catalyst is first contacted with at least a portion of the CO₂ before the epoxide is added.

In this context, “with at least a portion” means that, before the epoxide is added, either a portion of the total amount of CO₂ used or the entire amount of CO₂ is added.

Preferably only a portion of the CO₂ is added, and this portion is more preferably 20 to 80% and especially 55 to 65% by weight of the total amount of CO₂.

Typically, the CO₂ is added as a gas, and the amount of CO₂ is adjusted via the CO₂ gas pressure—as a function of temperature. At room temperature (23° C.) in the reactor, the CO₂ pressure before the addition of the epoxide (referred to hereinafter as initial CO₂ pressure), which corresponds to the preferred portion of CO₂, in the case of use of the zinc carboxylate catalysts, is 5 to 70 bar and especially 10 to 30 bar, and, in the case of use of the multimetal cyanide catalysts, 5 to 70 bar and especially 10 to 50 bar. Typical values for the initial CO₂ pressure are 15 bar for zinc carboxylate catalysts, and 50 bar for multimetal cyanide catalysts, each at 23° C.

All pressure figures are absolute pressures. The initial CO₂ pressure can be set discontinuously, all at once or divided into several steps, or else continuously, in a linear manner over a certain period or following a linear, or exponential or staged gradient.

In the selection of the initial CO₂ pressure, the pressure rise in the reactor due to the subsequent heating of the reactor to the reactor temperature should be noted. The initial CO₂ pressure (for example at 23° C.) should be selected such that the desired CO₂ end pressure is not exceeded at reaction temperature (e.g. 80° C.).

The contacting of the catalyst with CO₂ takes place generally at temperatures of 20 to 80° C., preferably 20 to 40° C. Particular preference is given to working at room temperature (23° C.). The duration of the contacting of catalyst and CO₂ depends on the reactor volume and is typically 30 sec to 120 min.

In general, the catalyst or the solution or dispersion of the catalyst in the inert reaction medium is stirred during the contacting with the CO₂.

Only after the catalyst has been contacted with CO₂ is the epoxide introduced into the reactor. The epoxide is typically injected into the reactor as such or preferably with a small amount of inert gas or CO₂.

The epoxide is added typically while stirring, and can be added all at once (especially in the case of a small reactor volume) or continuously over a period of generally 1 to 100 min, preferably 10 to 40 min, and the addition may be constant with time, or may follow a gradient, which may, for example, be ascending or descending, linear, exponential or staged.

The temperature on addition of the epoxide is generally 20 to 100° C., preferably 20 to 70° C. More particularly, it is possible either a) to add the epoxide at low temperature (e.g. room temperature 23° C.) and then to adjust the reactor to the reaction temperature T_{R} (e.g. 80° C.) or conversely b) first to adjust the reactor to the reaction temperature T_{R} and then to add the epoxide. Variant a) is preferred.

The reactor is accordingly brought to the reaction temperature T_{R} before or—preferably—after the addition of the epoxide. The reaction temperature is typically adjusted to 30 to 180° C., especially 50 to 130° C. This is typically accomplished by heating the reactor while stirring. The reaction temperature is typically 40 to 120° C., preferably 60 to 90° C.

After the reaction temperature has been attained, the remaining residual amount of CO₂ is added to the reactor, preferably while stirring, unless the entire amount of CO₂ has already been supplied on contacting of the catalyst with CO₂ (see above). Typically, the amount of CO₂ is again established via the CO₂ gas pressure.

Preference is given to adding CO₂ until the CO₂ pressure (referred to hereinafter as final CO₂ pressure), in the case of use of zinc carboxylate catalysts, is 1 to 200 bar, preferably 10 to 100 bar, and, in the case of use of multimetal cyanide catalysts, 20 to 200 bar, preferably 80 to 100 bar. Typical values for the final CO₂ pressure are 20 to 100 bar for zinc carboxylates, and 100 bar for multimetal cyanide catalysts.

All pressure figures are absolute pressures. The amount of CO₂ added in this process step (final CO₂ pressure) also depends naturally on the CO₂ portion which has already been added beforehand.

It is evident from the CO₂ pressures and reaction temperatures mentioned that the CO₂ in the reactor may be present in the supercritical state (i.e. in liquid form). Especially at final CO₂ pressures above 74 bar and reaction temperatures T_{R} above 31° C., the CO₂ is in the supercritical state. In contrast to customary chemical reactions in critical CO₂, the CO₂ in the present process is, however, not only the reaction medium but at the same time feedstock (reactant) and reaction medium.

The final CO₂ pressure can be established discontinuously, all at once, or continuously, as described for the initial CO₂ pressure.

On attainment of the final CO₂ pressure, it can be maintained by continued metered addition to replenish the CO₂ consumed, if necessary. When no further CO₂ is metered in, the CO₂ pressure generally falls during the reaction as a result of consumption of CO₂. This procedure is equally possible.

Typically, the time for completion of the polymerization reaction is 60 to 500 min, preferably 120 to 300 min. A typical value for this continued reaction time is 3 to 4 hours.

Typically, the reaction temperature is kept constant for this time; it can, however, also be raised or lowered according to the progress of the reaction.

The CO₂: epoxide ratios used in the process are guided in a known manner by the desired properties of the polymer. Typically, the ratio (weight ratio) of total amount of CO₂:total amount of epoxide is 1:1 to 2:1.

In a preferred embodiment, all aforementioned process steps are undertaken with exclusion of water: not only the catalyst but also the inert reaction medium, the CO₂ and the epoxide, are anhydrous or are rendered anhydrous in a customary manner.

After the polymerization reaction has abated, the reactor contents are worked up to give the polycarbonate. This is accomplished in a known manner. In general, the reactor is allowed to cool while stirring, pressure equalization is established with the environment (venting of the reactor), and the polycarbonate polymer is precipitated by adding the reactor contents to a suitable precipitation medium.

Typically, the precipitation medium used comprises alcohols such as methanol, ethanol, propanol, or ketones such as acetone. Methanol is preferred. It is advantageous to acidify the precipitation medium to pH 0 to 5.5 with hydrochloric acid or another suitable acid.

The precipitated polymer can be removed as usual, for example by filtration, and dried under reduced pressure.

In some cases, a portion of the polycarbonate reaction product is also present dissolved or dispersed in the precipitation medium, for example in the acidified methanol. This polycarbonate can be isolated in a customary manner by removing the precipitating agent. For example, the methanol can be distilled off under reduced pressure, for instance on a rotary evaporator.

The invention also relates to polyalkylene carbonates obtainable by the process described above.

The polyalkylene carbonates obtained in accordance with the invention can be processed further in many ways to give moldings, foils, films, coatings and sheetlike structures; on this subject, see, for example, WO 03/029325, pages 21 and 22.

The invention will now be described in further detail with reference to the following non-limiting examples.

### EXAMPLES

### 1. Catalyst Production

Silane-modified ZnO (modified) was prepared according to WO 2006/092442, especially examples 2 and 3 on pages 6 and 7.

A 1 l four-necked flask provided with stirrer bar, heating bath and water separator was initially charged with 35 g of triturated zinc oxide in 250 ml of absolute toluene. After addition of 53 g of glutaric acid, the mixture was heated to 55° C. while stirring for 2 hours. Thereafter, it was heated to boiling, in the course of which the water of reaction was distilled off by azeotropic means under reflux, until no further water was distilled over. The toluene was distilled off, and the residue was dried at 80° C. under high vacuum.

For comparison, an unmodified zinc glutarate (standard) was prepared according to WO 03/029325, example 1 on page 22.

### 2. Polymerization

The polypropylene carbonate was prepared analogously to WO 2003/029325, especially example 2b on page 23.

12 g of zinc glutarate from example 1 were initially charged in the reactor. A 3.5 l autoclave with mechanical stirrer was used. After the reactor had been closed, it was purged repeatedly with N₂ gas. Then 620 g of toluene were added and 6 bar of CO₂ was injected into the reactor at room temperature (23° C.). Subsequently, 310 g of propylene oxide were injected into the reactor and heated to 80° C. Thereafter, CO₂ was injected into the reactor at 80° C. until a CO₂ pressure of 40 bar was attained. The reactor was kept at 80° C. for 4 h, in the course of which no further CO₂ was metered in. Subsequently, the mixture was allowed to cool to room temperature.

### 3. Workup

The workup was effected according to WO 03/029325 A1, especially example 2c on page 24. The reactor was vented and the reactor contents were poured into 1 l of methanol which had been acidified with 5 ml of conc. hydrochloric acid (37% by weight). A polymer precipitated out, which was filtered off and dried at 60° C. under reduced pressure overnight.

### 4. Analysis

The results of the catalytic copolymerization and of the polypropylene carbonate obtained are shown in table 1 below.

| | | | | | % |
|---|---|---|---|---|---|
| | | | | | polypropylene |
| | | | g of | | carbonate, |
| Pressure | | PO con- | polymer/ | Mₙ [g/mol], | % cyclic |
| cat. | PO:cat | version | g of Zn | PDI | carbonate |
| 40 bar | | | | | |
| standard | 88 | 33.2 | 45.3 | 35 000, 14.6 | 94.4, 1.8 |
| modified | 88 | 58.6 | 79.6 | 49 000, 11.4 | 96.1, 1.0 |
| 7 bar | | | | | |
| standard | 88 | 13.4 | 38 | | 74.7, 28.6 |
| modified | 88 | 28.1 | 18 | | 92.0, 6.0 |

The PO conversion is determined via the pressure drop. The number-average molecular weight and the polydispersity index (PDI) are determined from gel permeation chromatography measurements (GPC). The polypropylene carbonate and cyclic carbonate contents are derived from NMR analyses.

The zinc glutarate catalysts are insensitive to atmospheric oxygen. However, the air humidity influences both the handling and the activity of the catalyst. The unmodified standard catalyst forms agglomerate (lumps) of a few centimeters in diameter in the course of storage under standard atmospheric conditions. Under the same storage conditions, this is not the case for the silane-modified analog. The inventive catalyst is thus notable for improved storage stability and meterability over a period of at least 6 to 12 months.

The activity of the unmodified standard zinc glutarate catalyst depends strongly on the degree of drying, i.e. is strongly connected to the water content of the catalyst. The silane-modified zinc glutarate system gives much more stable polymerization results over the moisture range examined.

Both catalysts are active in the range from 0% water to 2 μL of H₂O per 1 g of catalyst. The activity of the modified zinc glutarate catalyst is constant and reproducible down to an addition of 1 μL of water per 1 g of catalyst. This catalyst does not need any additional activation after drying, as is the case for the unmodified zinc glutarate. In the fully dried state, it exhibits zero to only very low activity. Only by virtue of addition of water or absorption of air humidity is the activity maximum attained here.

The modified catalyst gives, at CO₂ pressure 20 bar, in the fully dried state, twice as much polymer as the unmodified zinc glutarate. As the polymerization pressure is lowered, the performance of the modified system compared to the unmodified standard becomes ever better. At 10 bar, 6 bar and 5 bar, it gives three times as much polymer in the same time. At lower pressures, in the case of use of the unmodified standard catalyst, not only the low activity but firstly also increasing softening of the polymer occurs as a result of an elevated polyether content in the product. Secondly, an influence on the glass transition temperature T_{g} is visible. For polymers prepared at relatively low pressures, it falls to below 10° C., whereas it does not fall below 20° C. in the case of use of the modified catalyst.

The two catalysts additionally differ in bulk density. This was determined to DIN ISO 697. In the case of the unmodified zinc glutarate, 0.485 g of catalyst takes up a volume of 1 ml. The silane-modified catalyst is notable for a much lower bulk density of 0.299 g/ml.

What is claimed is:

1. A zinc salt of C₄₋₈-alkanedicarboxylic acids, obtainable by reacting a C₄₋₈-alkanedicarboxylic acid with surface-modified zinc oxide particles, said surface-modified zinc oxide particles being obtainable by treatment of zinc oxide particles with organosilanes, silazanes and/or polysiloxanes and subsequent heat treatment and/or UV irradiation of treated zinc oxide particles.

2. The zinc salt according to claim 1, wherein the C₄₋₈-alkanedicarboxylic acid is selected from glutaric acid and adipic acid.

3. The zinc salt according to claim 1, wherein the zinc oxide particles are treated with alkoxyalkylsilanes.

4. The zinc salt according to claim 1, wherein the zinc oxide particles are obtainable by suspending and/or dispersing ZnO particles in polar protic solvents, subsequently treating them with alkoxyalkylsilanes and treating the thus produced ZnO particles which have been treated with alkoxyalkylsilanes in an aqueous medium with UV irradiation.

5. A process for preparing a zinc salt according to claim 1, which comprises performing the process steps specified.

6. A process for preparing polyalkylene carbonates by polymerizing carbon dioxide with at least one epoxide of the general formula (I) 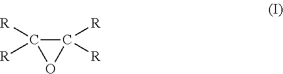
where R is independently H, halogen, NO₂, CN, COOR′ or C₁₋₂₀-hydrocarbyl radical which may be substituted, where one of the R radicals may be also OH, and where two R radicals together may form a C₃₋₅-alkylene radical, R′ is H or C₁₋₂₀-hydrocarbyl radical which may be substituted, which comprises performing the polymerization over a catalyst according to claim 1.

7. The process according to claim 6, wherein the catalyst is used in anhydrous form.

8. The process according to claim 6, wherein the epoxide is selected from ethylene oxide, propylene oxide, butene oxide, cyclopentene oxide, cyclohexene oxide, i-butene oxide, acrylic oxides or mixtures thereof.

9. The process according to claim 6, which comprises essentially the following process steps:
drying or rendering anhydrous the catalyst,
initially charging the anhydrous catalyst in a polymerization reactor,
optionally adding an inert reaction medium,
adding carbon dioxide,
adding the epoxide,
heating the reactor to the reaction temperature,
optionally adding further carbon dioxide and
after the polymerization reaction has abated, working up the reactor contents to give the polycarbonate, where adding the epoxide and heating the reactor may be exchanged.

10. Polyalkylene carbonates obtainable by a process according to claim 6.
